(19) United States
(12) Patent Application Publication
(10) Pub. No.: US 2020/0301050 A1
(43) Pub. Date: Sep. 24, 2020

(54) Optical Element Having Alternating Refractive Index Changes, and Use Thereof

(71) Applicant: Laser Zentrum Hannover e.V., Hannover (DE)

(72) Inventors: Marco Jupé, Hannover (DE); Detlev Ristau, Langenhagen (DE)

(21) Appl. No.: 16/894,959

(22) Filed: Jun. 8, 2020

Related U.S. Application Data
(63) Continuation of application No. PCT/EP2018/082502, filed on Nov. 26, 2018.

(30) Foreign Application Priority Data
Dec. 6, 2017 (DE) 10 2017 129 069.9

(51) Int. Cl. G02B 5/08; G02B 5/20; G02B 5/28

(52) U.S. Cl. CPC G02B 5/0883; G02B 5/284; G02B 5/207; G02B 5/0816

(57) ABSTRACT

An optical element has a design wavelength λ, an optical axis and alternating refractive index changes along the optical axis. The alternating refractive index changes form three reflectors and two optical resonators for light of the design wavelength λ incident along the optical axis, wherein each of the resonators is arranged between two of the reflectors. At least one of the resonators includes a Kerr-active material; and the two optical resonators differ with regard to non-linear components I_{Res}(i)·n₂(i) of their total refractive indices n(i)=n₀(i)+I_{Res}(i)·n₂(i) by at least 50% of the smaller one of the non-linear components in terms of absolute value, wherein I_{Res}(i) is a resulting intensity of the light of the design wavelength λ that results within the respective resonator due to its arrangement between the respective reflectors, and wherein n₂(i) is a non-linear refractive index of the respective resonator.

### CROSS REFERENCE TO RELATED APPLICATIONS

This application is a continuation to International Application PCT/EP2018/082502 with an international filing date of Nov. 26, 2018 entitled “Optical element having alternating refractive index changes, and use thereof” and claiming priority to German Patent Application No. DE 10 2017 129 069.9 entitled “Optisches Element mit alternierenden Brechungsindexänderungen und dessen Verwendung” and filed on Dec. 6, 2017.

### FIELD OF THE INVENTION

The present invention relates to an optical element comprising a design wavelength λ, an optical axis, and alternating refractive index changes along the optical axis. More particular, the present invention relates to such an optical element in which the alternating refractive index changes form at least three reflectors and at least two optical resonators for light of the design wavelength λ incident along the optical axis, wherein, along the optical axis, each of the at least two optical resonators is arranged between two of the at least three reflectors. Even more particular, the present invention relates to such an optical element in which at least one of the at least two optical resonators includes a Kerr-active material.

### BACKGROUND OF THE INVENTION

European Patent EP 0 541 304 and U.S. Pat. No. 5,237,577, which belong to the same patent family, disclose an optical apparatus having a first and a second reflective element arranged at a distance to form a Fabry-Perot-Etalon having a plurality of resonance frequencies between the two reflective elements. Semiconductor material arranged between the first and the second reflective elements of the optical apparatus has a non-linear optical absorption at a predefined optical frequency. This optical frequency is located between two neighboring optical resonance frequencies such that it is essentially at one optical frequency which corresponds to anti-resonant conditions of the Fabry-Pérot-Etalon. The semiconductor material acts as a saturable absorbed element which only becomes transparent at a saturation intensity of the light. The known optical apparatus is also designated as a saturable Fabry-Pérot-Absorber. It belongs to the SESAMs (semiconductor saturable absorber mirrors), and it may be used for mode coupling or q-switching in a laser resonator. In the practical application of SESAMs, problems often occur with regard to surge immunity at high light intensities, optical losses and degradation of the absorbers. Further, no practically usable absorbers are available in the wavelength range below 780 nm.

European patent application publication EP 3 217 489 A1 and U.S. Pat. No. 10,191,352, which belong to the same patent family, disclose an optical element comprising a stack of optical layers made of materials have third-order non-linearity. The optical element is provided for modulating light depending on its intensity. Specifically, the reflectivity or the transmissivity of the optical element shall be dependent on the intensity of the light. This dependency is based on the Kerr-effect according to which the total refractive index n in case of materials having a third-order non-linearity depends on the intensity of the light and a non-linear refractive index n₂ according to n=n₀+I·n₂. In addition to the Kerr-effect, the percentage of absorption of the light and thus the thermal load to the optical element is told to be increasing with the product I·n₂ of the intensity I of the light and the non-linear refractive index n₂. According to EP 3 217 489 A1 and U.S. Pat. No. 10,191,352, the non-linear refractive index n₂ shall thus remain below 10⁻¹² cm²/W to make the optical element robust with regard to high light intensities. It may be taken from EP 3 217 489 A1 and U.S. Pat. No. 10,191,352 that doped polymer films have a non-linear refractive index n₂ of about 1.7×10⁻⁶ cm²/W. The stack of the Kerr-active optical layers of the known optical element may have at least one full wave cavity which is resonant at a central wavelength of the light. The resulting resonator amplifies the field within the stack so that the non-linear effect on the refractive index is achieved even with moderate intensities of the incident light. With a plurality of such cavities, the optical Kerr effect shall be further enhanced.

In M. Jupé et al.: Schnelle Schalter durch präzise ausgelegte Mehrschichtsysteme (2016), see https://www.photonikforschung.de/service/nachrichten/detailansicht/schnelle-schalter-durch-praezise-ausgelegte-mehrschichtsysteme.html, a Kerr-band-switch is proposed to realize a mode coupling concept which is an alternative to the use of saturable semiconductor mirrors, i. e. of so called SESAMs (“semi¬conductor-saturable-absorber-mirrors”). This alternative mode coupling concept is based on utilizing the Kerr-effect in thin layer systems. The Kerr-band-switch consists of a dielectric layer system into which one or more Kerr-active layers are embedded. With the development of high light intensities, the refractive index of these Kerr active layers changes slightly. This has an influence on the transfer behavior of the layer system. Thus, the Kerr-band-switch shall allow for a low loss q-switching in a laser resonator.

There still is a need of an optical element suitable as an optical switch in a laser resonator which has a high damage threshold such that it is also suitable for switching light of high intensity and that is also suitable for switching of light of wavelength below 780 nm.

### SUMMARY OF THE INVENTION

The present invention relates to an optical element optical element comprising a design wavelength λ, an optical axis, and alternating refractive index changes along the optical axis. The alternating refractive index changes form at least three reflectors and at least two optical resonators for light of the design wavelength λ incident along the optical axis. Along the optical axis, each of the at least two optical resonators is arranged between two of the at least three reflectors. At least one of the at least two optical resonators includes a Kerr-active material. The at least two optical resonators have total refractive indices n(i)=n₀(i)+I_{Res}(i)·n₂(i), wherein I_{Res}(i) is a resulting intensity of the light of the design wavelength λ incident along the optical axis that results within the respective one of the at least two reflectors due to an arrangement of the respective one of the at least two reflectors between the respective two of the at least three reflectors, and wherein n₂(i) is a non-linear refractive index of the respective resonator. The at least two optical resonators differ with regard to non-linear components I_{Res}(i)·n₂(i) of their total refractive indices by at least 50% of that one of the non-linear components I_{Res}(i)·n₂(i) that is the smaller one in terms of absolute value.

The invention also relates to an optical element comprising a design wavelengths λ, an optical axis, and alternating refractive index changes along the optical axis. The alternating refractive index changes form at least two reflectors and at least one optical resonator for light of the design wavelength λ incident along the optical axis. Along the optical axis, the at least one optical resonator is arranged between the at least two reflectors. The at least one optical resonator includes a Kerr-active material such that the at least one optical resonator has a total refractive index n(i)=n₀(i)+I·n₂(i) dependent on the intensity I of the light. The Kerr-active material of the at least one optical resonator has a total refractive index n_{Kerr}=n₀+I·n₂, wherein an absolute value of a non-linear refractive index n₂ of the Kerr-active material is at least 1×10⁻¹⁴ cm²/W, and the Kerr-active material of the at least one optical resonator is selected from polymers and materials doped with nanoparticles, the nanoparticles comprising at least one of a metal or a semiconductor.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 schematically depicts an embodiment of the optical element of the invention.

FIG. 2 illustrates the changes of the spectral properties of a first practical embodiment of the optical element of the invention.

FIG. 3 shows the results of intensity-dependent transmission measurements at the first practical embodiment of the optical element of the invention according to FIG. 2.

FIG. 4 illustrates changes of the spectral properties of a first variant of the first practical embodiment of the optical element according to FIG. 2.

FIG. 5 illustrates changes of the spectral properties of a second variant of the first practical embodiment of the optical element of the invention according to FIG. 2.

FIG. 6 illustrates changes of the distribution of the field strength over the second variant of the first practical embodiment of the optical element of the invention, the changes being associated with the changes of its spectral properties according to FIG. 5.

FIG. 7 illustrates changes of the spectral properties of a second practical embodiment of the optical element of the invention.

FIG. 8 schematically illustrates a first use of an optical element of the invention in a laser resonator; and

FIG. 9 as schematically as FIG. 8 illustrates another use of another optical element of the invention in a laser resonator.

### DETAILED DESCRIPTION

The invention relates to an optical element having an optical axis, a design wavelength and alternating refractive index changes along the optical axis. The alternating refractive index changes form reflectors for light of the design wavelength incident along the optical axis in at least three areas following to each other along the optical axis, and an optical resonator for the light of the design wavelength incident along the optical axis between each pair of neighbouring reflectors. At least one of the resonators includes a Kerr-active material. In the optical element, at least two of the resonators provided between the reflectors differ with regard to non-linear components I_{Res}(i) n₂(i) of their total refractive indices n(i)=n₀(i)+I_{Res}(i)·n₂(i) by at least 50% of that one the two non-linear components I_{Res}(i)·n₂(i) that is the smaller one in view of absolute value. Here, I_{Res}(i) is a resulting intensity of the light of the design wavelength incident along the optical axis within the respective resonator, which results due to the arrangement of the respective resonator between the reflectors, and n₂(i) is a non-linear refractive index of the respective resonator.

Insofar as here and in other parts of the description as well in the claims the term “light” is used, this term refers to an electromagnetic radiation which is selected from a wavelength range extending from infrared to ultraviolet. Particularly, it may be laser radiation. Here and in other parts of the description as well as in the claims, the term “intensity” of the light refers to the spatial power density of the electromagnetic radiation. All the intensities I_{Res}(i) resulting in the reflectors depend on the input intensity of the light incident along the optical axis. Thus, it is to be understood that the ratio of the non-linear components I_{Res}(i)·n₂(i) of the total refractive indices n(i)=n₀(i)+I_{Res}(i)·n₂(i) of the individual resonators is examined at a same input intensity.

The term “optical axis” used here and in other parts of the description as well as in the claims does not necessarily implicate that the optical axis has a fixed spatial relation to structures of the optical element, so that it, for example, runs orthogonal to layers of the layer construction of the optical element. Instead, the optical axis is defined by the effect of the optical element on light incident along the optical axis. Thus, the light may also be incident on the layers of the layer construction of the optical element at an angle differing from 90°. This may, for example, be utilized to purposefully use the optical element for influencing light of a certain polarization direction, only.

The design wavelength of the optical element is that wavelength at which the optical element particularly strongly responds to a high intensity of the light by changing its optical properties between reflection and transmission. For this design wavelength, at least three reflectors are provided by the alternating refractive index changes, between which two resonators are arranged. In this context, the formulation “alternating refractive index changes” stands for decreases and increases of the refractive index of the optical element along the optical axis. These decreases and increases of the refractive index may be stepwise between pairs of two layers following to each other along the optical axis. Alternatively, these decreases and increases of the refractive index may display a steady course like in a so called Rugate-structure. Further, the maximum and minimum values of the refractive index reached by the alternating refractive index changes may be constant, or they may vary over the optical element along the optical axis. The number of alternating refractive index changes necessary for forming a reflector depends on the height of the refractive index changes. With sufficiently high refractive index differences, two refractive index changes which correspond to three consecutive layer in a layer structure can be sufficient for forming a reflector. With smaller refractive index differences, more refractive index changes are needed. The period of the alternating refractive index changes along the optical axis is typically one half of the design wavelength, the optical distance of the individual refractive index changes being a quarter of the design wavelength. Each of the resonators typically has an optical length in the direction of the optical axis of one half of the design wavelength or of a plurality of halves the design wavelength. There is no need that the optical dimensions of the reflectors and resonators exactly comply with the preceding specifications, or that the optical dimensions of all the reflectors and resonators comply with the preceding specifications. It is sufficient that the reflectors and resonators essentially corresponds to these specifications.

In the optical element of the invention, the Kerr-active material may be strongly localized. Particularly, it is possible that the Kerr-active material is only arranged in the at least one resonator. Even then, the Kerr-active material needs not to be present everywhere in the resonator but it may be limited to a partial area of the resonator. In other words, the at least one and also any other resonator of the optical element of the invention may have a multilayered structure. Due to the strong localization of the Kerr-active material in the optical element of the invention, it is ensured that even then, when the percentage of the absorption of the light by the Kerr-active material increases with the Kerr-effect, the absolute absorption and thus the thermal load to the optical element in its entirety remains very small. At the same time, the optical element of the invention has a high efficiency, i. e. a high sensitivity to an increasing intensity of the light of the design wavelength with regard to the changes of its optical properties between reflection and transmission. This is due to the fact that its reflectors are tuned with regard to each other in such a way that they display significant different Kerr-effects, i. e. that they are strongly differently put out of tune or tuned with increasing intensity of the light incident along the optical axis. Due to this putting the resonators out of tune or tuning the resonators with regard to each other, the results of the Kerr-effect on the optical properties of the optical element with regard to a change between reflection and transmission at the design wavelength is amplified. Further, the Kerr-active material is used there, where the highest intensity of the incident light results, i. e. in one of the resonators.

Particularly, the resonators, out of a starting state at low intensity of the light of the design wavelength incident along the optical axis in which at least one of the resonators is put out of tune with regard to an ideal resonator at the design wavelength, may all be ideally tuned to the design wavelength with increasing intensity of the light of the design wavelength so that the optical element becomes transparent for the light of the design wavelength. Vice versa, resonators ideally tuned at a low intensity of the light of the design wavelength may be put out of tune with regard to each other at high intensity of the light of the design wavelength.

Insofar as optical materials are available for forming reflectors and resonators arranged between the reflectors by alternating refractive index changes, the optical element of the invention is adaptable to design wavelengths in an extended range from ultraviolet to infrared, because at least a certain Kerr-activity is present in all optical materials.

The criterion, that the at least two of the resonators differ in their non-linear components I_{Res}(i)·n₂(i) of their total refractive indices n(i)=n₀(i)+I_{Res}(i)·n₂(i) by at least 50% of the smaller one of the two non-linear components I_{Res}(i)·n₂(i) with regard to value, includes the possibility that the two non-linear refractive indices n₂(i) of the two resonators have different signs. It also includes the possibility that the two non-linear components I_{Res}(i)·n₂(i) predominantly differ by different resulting intensities I_{Res}(i) in the individual resonators. This resulting intensity I_{Res}(i) includes the intensity increase in the resonators resulting from the formation of the resonators and of the reflectors delimiting the resonators. The resulting intensities I_{Res}(i) in the individual resonators are always compared at a same intensity of the light of the design wavelength incident along the optical axis. This comparison may either be made at a low intensity and/or at a high intensity of the light of the design wavelength incident along the optical axis.

In the optical element of the invention, the reflectors may completely or at least predominantly be made of non-Kerr-active materials which have a total refractive index n(k)=n₀(k)+I·n₂(k), wherein a value of a non-linear refractive index n₂(k) is at maximum half the value of the non-linear refractive index n₂(i) of the at least one resonator with the Kerr-active material. The non-Kerr-active or Kerr-inactive material of the reflectors is thus defined with respect to the Kerr-active material of the at least one resonator by means of a difference in value of the respective non-linear refractive indices n(k) and n(i), respectively. This difference in value may even be higher and have the result that the value of the non-linear refractive index n₂(k) of the materials of the reflectors is at maximum a quarter or even at maximum an eighth of the value of the non-linear refractive index n₂(i) of the at least one resonator with the Kerr-active material.

With regard to absolute figures, the value of the non-linear refractive index n₂(k) of the total refractive index n(k) of the materials of the reflectors may be 4.0×10⁻¹⁶ cm²/W at maximum or even 3.0×10⁻¹⁶ cm²/W at maximum or even 2.0×10⁻¹⁶ cm²/W at maximum. Even the typically higher non-linear refractive indices of usual high refractive optical materials which are suitable for higher light intensities and correspondingly for optical elements in laser resonators are in this range. In that, in the optical element of the invention, different Kerr-effects in different resonators, which are documented by different non-linear components I_{Res}(i)·n₂(i) of the total refractive indices n(i)=n₀(i)+I_{Res}(i)·n₂(i), are used to cause the desired change between reflection and transmission of the light of the design wavelength, a material only having a low Kerr-activity as compared to absolute standards is sufficient as the Kerr-active material in the at least one resonator. However, this does by no means exclude the use of materials of higher Kerr-activity, i. e. with high non-linear refractive indices.

In the same way as the reflectors, also at least a further one of the resonators may at least predominantly be made of non-Kerr-active materials so that it has a refractive index n(p)=n₀(p)+I−n₂(p), wherein the value of the non-linear refractive index n₂(p) is at maximum a half or even at maximum a quarter or even at maximum an eighth of the value of the non-linear refractive index n₂(i) of the at least one resonator with the Kerr-active material. Also in absolute terms, the value of the non-linear refractive index n₂(p) of the total refractive index n(p) of the at least one further resonator may be as high as in the non-Kerr-active materials of the reflectors, i. e. 4.0×10⁻¹⁶ cm²/W at maximum or 3.0×10⁻¹⁶ cm²/W at maximum or 2.0×10⁻¹⁶ cm²/W at maximum.

In the optical element of the invention, typically, not only two but three, four or five resonators are arranged between the reflectors. Generally, the number of the resonators may even be higher. However, with increasing number of the resonators, the total construction of the optical element becomes more complex, and this complexity is rarely rewarding in terms of the enhancement of the optical properties of the optical element achieved.

Titanium dioxide (TiO₂) may be mentioned as a Kerr-active material of the at least one of the resonators, which can be used in the optical element of the invention. Non-Kerr-active materials of at least one further of the resonators may essentially be made of Ta₂O₅ or any other metal oxide. Silicon dioxide (SiO₂) is suitable as a low refractive non-Kerr-active material of the reflectors, and Ta₂O₅ or any other metal oxide may be used as a high-refractive non-Kerr-active material of the reflectors. These materials may, without destruction, be subjected to the high intensities of the laser light in a laser resonator in which a titanium sapphire crystal is arranged as a laser active material.

As already mentioned, in the optical element of the invention, even Kerr-active materials may be used in the at least one resonator which, from an absolute point of view, only have a low Kerr-activity. Nevertheless, a high Kerr-activity i. e. a high value of the non-linear refractive index n₂ of the Kerr-active material which has a total refractive index n_{Kerr}=n₀+I·n₂ depending on the intensity I of the light may be advantageous. This value |n₂| may, for example, be at least 1×10⁻¹⁴ cm²/W or even at least 1×10⁻¹² cm²/W or even at least 1×10⁻¹⁰ cm²/W or even at least 1×10⁻⁸ cm²/W or even at least 1×10⁻⁶ cm²/W. Thus, the value |n₂| may particularly be much higher than indicated as suitable in EP 3 217 489 A1 which set a limit of 10⁻¹² cm²/W to the value |n₂|. Due to the little amount of the Kerr-active material which is often limited to a single resonator, the energy of the light absorbed in the new optical element of the invention and, thus, also the resulting heating up of the optical element remains small, although it definitely increases with the Kerr-effect occurring.

The afore-mentioned high and very high non-linear refractive indices n₂ of the total intensity indices n_{Kerr} of the Kerr-active material may, for example, be achieved by polymers and/or by doping with nanoparticles. Thus, the Kerr-active material of the at least one of the resonators may be a polymer and/or doped with nanoparticles which comprise at least one metal or one semiconductor. It is to be mentioned here that in this specification the term semiconductor refers to the chemical composition of the material so that the semiconductor may, for example, be GaAs. The nanoparticles by which the Kerr-active material is doped and which have an increasing effect on the Kerr-activity, may particularly have a particle size in a range from 1 to 100 nm and/or predominantly be made of gold, silver, platinum, palladium or copper, i. e. of a noble metal. It may be left open via which mechanism the nanoparticles increase the Kerr-activity of the Kerr-active material. In any case, their increasing effect on the Kerr-activity can be proven.

In using Kerr-active material which is essentially made of a polymer and/or doped with nanoparticles to have a high Kerr-activity in a resonator between reflectors made of alternating refractive index changes, an invention by its own is to be seen, i. e. independently on whether two or more resonators of different Kerr-activity are present.

With regard to use of the optical element of the invention, it has already been mention that it can be utilized that an increase of the intensity I of the light of the design wavelength incident along the optical axis either reduces or increases the transmission of the optical element in a passband around the design wavelength. Thus, the optical element may particularly be used as an optical switch that switches between transmission and reflection depending on the intensity of the light of a wavelength in the transmission band incident along the optical axis.

If the switching with increasing intensity of the incident light occurs from transmission to reflection, a mode coupling or q-switching may be realized in a laser resonator. By switching from reflection to transmission, the intensity of the light in a laser resonator may be limited to a maximum or a single high energy pulse may be coupled out of a laser resonator, for example.

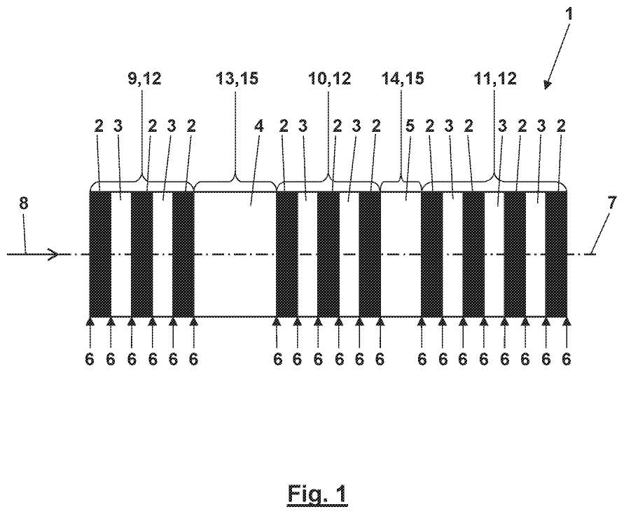

Referring now in greater detail to the drawings, an optical element 1 of the invention schematically depicted in FIG. 1 comprises consecutive layers 2 to 5. By means of different refractive indices of the layers 2 to 5, a stepwise refractive index change 6 is formed between every two directly consecutive layers 2 and 3, 3 and 2, 2 and 4, 4 and 2, 2 and 5, and 5 and 2. The refractive index changes 6 follow to each other along an optical axis 7, and, for light having a design wavelength λ and incident along the optical axis 7, the refractive index changes 6 are provided at certain distances so that different areas 9 to 11, 13 and 14 of the device 1 following to each other along the optical axis 7 have different functions. In the three areas 9, 10 and 11, the distances of the refractive index changes are equal to λ/4. This means that the optical thicknesses of the layers 2 and 3 are each equal to a quarter of the design wavelength λ. In this way, the areas 9, 10 and 11 form reflectors 12 for the light 8. Between every two of these reflectors 12, resonators 15 for the light of the design wavelength λ are formed in the areas 13 and 14. The corresponding optical thickness of the layers 4 and 5 which are arranged in these areas 13 and 14 is λ/2 or a an integer multitude of λ/2. Generally, all resonators 15 of the optical element 1 may be formed by layers 4 and 5 of an equal optical thickness. However, the resonators 15 are not completely identical. Instead, they differ with regard to a Kerr-activity of their materials and/or with regard to the resulting intensity I_{Res} of the light 8 in the areas 13 and 14 so that clearly different Kerr-effects are produced in the areas 13 and 14. Particularly, at least two of the resonators 15 of the optical element differ with regard to their non-linear components I_{Res}(i)·n₂(i) of their total refractive indices n(i)=n₀(i)+I_{Res}(i)·n₂(i) by at least 50% of that one of the two non-linear components I_{Res}(i)·n₂(i) having the smaller absolute value. Here, I_{Res}(i) is the already mentioned resulting intensity of the light 8 in the area 13, 14 of the respective reflector 15, and n₂(i) is a non-linear refractive index of the respective resonator.

Due to the different Kerr-effect in the areas 13 and 14, which increases with increasing intensity I of the light 8, the resonators 15 are differently put out of tune or, if they have been out of tune at low intensity of the light 8, tuned with regard to each other. In this way, the optical properties of the optical element 1 for the light 8 having the design wavelength λ varies with increasing intensity between transmission, which is present if all resonators 15 are tuned to the design wavelength λ at the respective intensity I, and reflection, which is present if at least one of the resonators, but not all resonators 15 to a same extent, are put out of tune with regard to the design wavelength λ.

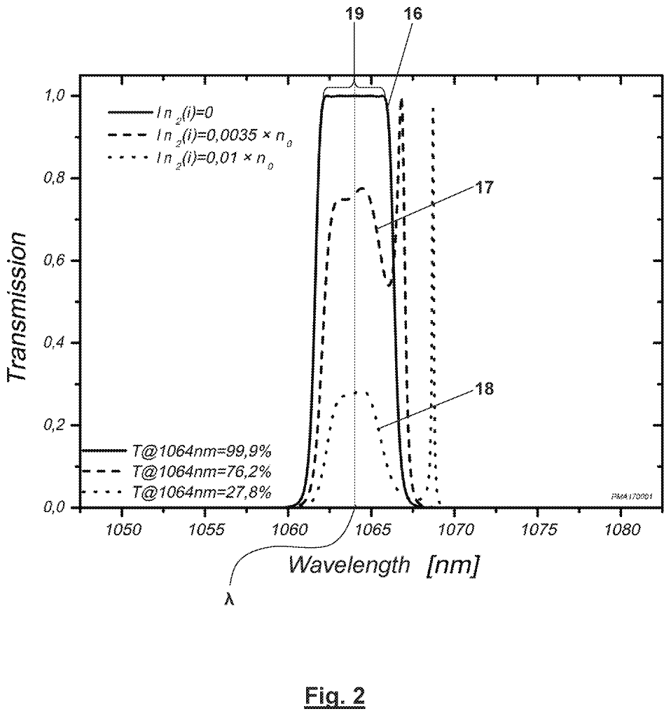

FIG. 2 illustrates the changes to the spectral properties of a first practical embodiment of the optical element 1 of the invention comprising a total of 97 layers 2 to 5 which form six reflectors 12 and five resonators 15 arranged between the reflectors 12. In FIG. 2, the consequence of a Kerr-effect only occurring in the central resonator 15 is illustrated. A curve 16 shows the starting situation without variation of the refractive index in the area of the central resonator. A curve 17 shows the consequence of a variation of the refractive index n(i) in the area of the central resonator by 0.35%, and a curve 18 shows the consequence of a change of the refractive index n(i) in the area of the central resonator by 1%. With the refractive index change in the area of the central resonator, the transmission in a relative broad passband 19 around the design wavelength λ of over 95% at the beginning goes down to below 30%. At the design wavelength λ of 1064 nm, the transmission of 99.9% at the beginning goes down to 76.2% with a change of the refractive index n(i) in the area of the central resonator by 0.5%, and even down to 27.8% with a change of the refractive index n(i) in the area of the central resonator by 1%.

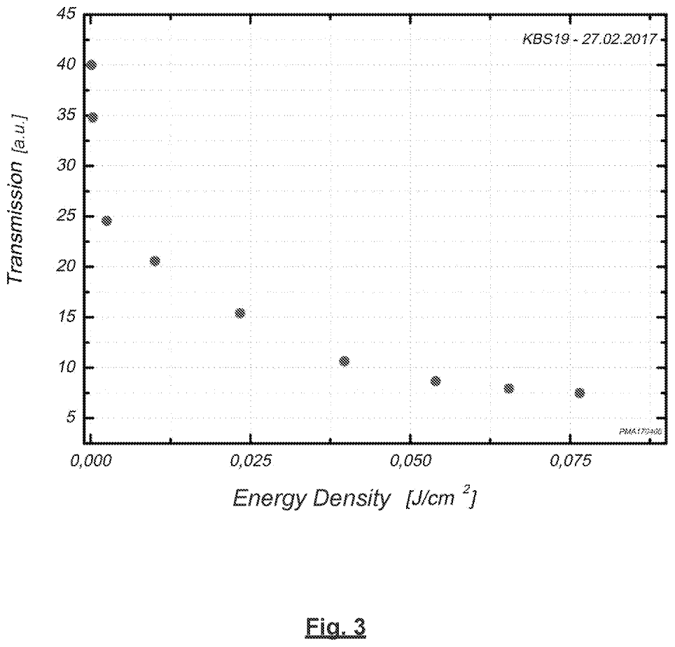

FIG. 3 shows results of intensity dependent transmission measurements at the first practical embodiment of the optical element 1 of the invention according to FIG. 2, i. e. with a Kerr-effect selectively increasing in the central resonator 15 with increasing intensity of the light 8. However, the optical element 1 at which the transmission measurements have actually been carried out was designed for a design wavelength λ of 1030 nm. It can be seen how laser pulses having the design wavelength λ of 1030 nm and a pulse duration of 350 fs are transmitted by the optical element 1 at reduced percentages with increasing energy density.

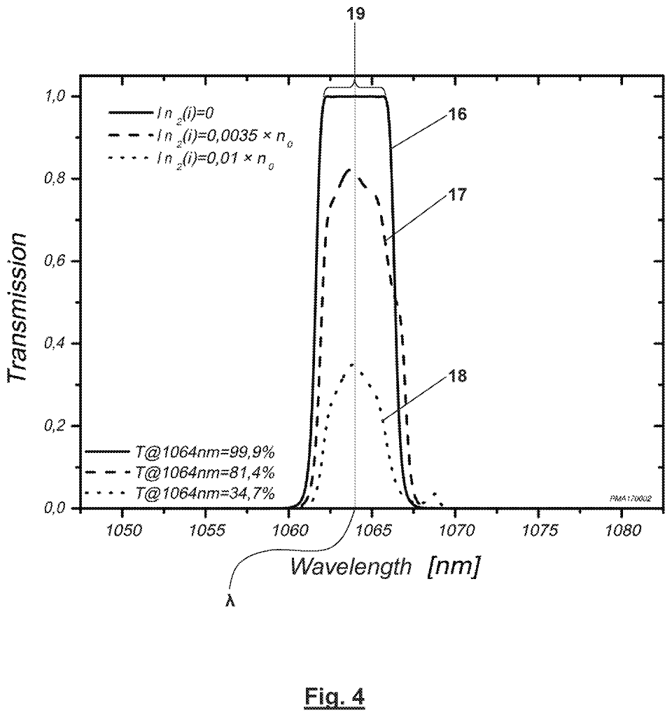

FIG. 4 shows variations of the spectral properties of the optical element with 97 layers including five resonators which result, when the refractive index of the second resonator in the direction of incidence of the light 3 according to FIG. 1 varies by 0.35% and 1%, respectively. Here, the side maximum of the transmission at a higher wavelength visible in FIG. 2 is not present. The transmission at the design wavelength λ of 1064 nm drops from 99.9% to 81.4% with the variation of the refractive index n(i) in the area of the second resonator by 0.35% and to 34.7% with the variation of the refractive index n(i) in the area of the second resonator by 1%.

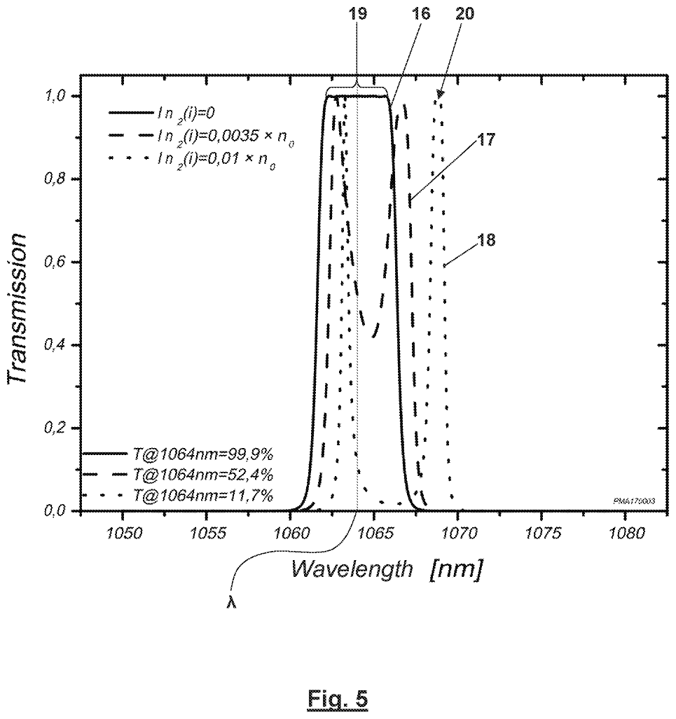

FIG. 5 is also based on the same optical element 1 comprising 97 layers including five resonators and shows the effect of a variation of the refractive index in the second and fourth resonator. Here, the transmission for the longer wavelength part of the passband 19 around the design wavelength λ goes down to nearly zero. Particularly, the transmission at the design wavelength λ of 1064 nm drops from 99% to 52.4% with the variation of the refractive index n(i) in the area of the second and fourth resonator by 0.35% and to only 11.7% with the variation of the refractive index n(i) in the area of the second and fourth resonators by 1%. Vice versa, in a further narrow bandwidth passband 20 at a higher wavelength, in which the optical element 1 is at first completely reflective, a transmission of over 95% is present with a variation of the refractive index in the second and fourth resonators by 1%. Both the reduction of the transmission in a part of the passband 19 and the increase of the transmission in the further passband 20 may be purposefully utilized in using the optical element 1 according to FIG. 1.

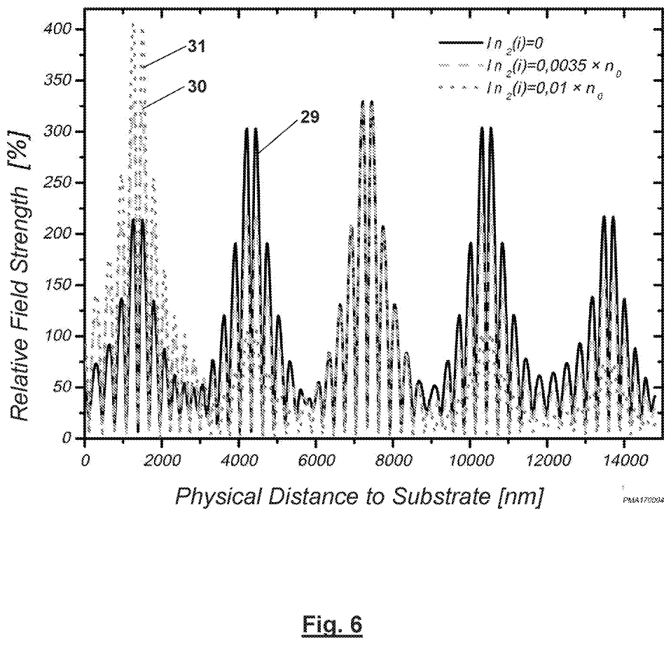

FIG. 6 shows the variation of the distribution of the field strength over the optical element 1 with 97 layers including five resonators which results from the variation of its spectral properties according to FIG. 5. Here, a curve 29 corresponds to the distribution of the field strength over the optical element 1 without Kerr-effect, whereas curves 30 and 31 correspond to the distributions of the field strength with a variation of the refractive index n(i) in the area of the second and fourth resonators by 0.35% and 1%, respectively. Each distribution of the field strength comprises local maxima in the area of the resonators 15. With the Kerr-effect increasing, i.e. with increasing variation of the refractive index n(i) in the area of the second and fourth resonators, the field strength concentrates to the left hand area of the layered structure, which corresponds to decreasing transmission and correspondingly increasing reflection of the light 8 incident from the left.

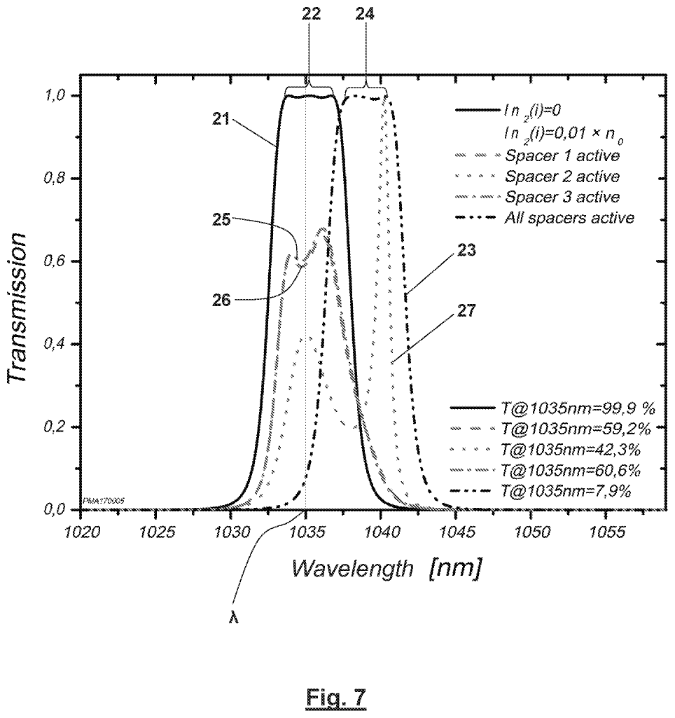

FIG. 7 shows the variation of the spectral properties of another optical element of the invention comprising a total of 59 layers 2 to 5 which form three resonators 15 between four reflectors 4. A curve 21 indicates the starting situation in which all resonators 15 are tuned to the design wavelength λ. As a consequence, there is a passband 22 around the design wavelength λ. When the refractive index of all resonators 15 is varied by 1%, i. e. increased by 1%, the course of the transmission T over the wavelength depicted by a curve 23 results. This curve 23 corresponds to a pure shift of the passband 22 into a passband 24 of a same width but at a longer wavelength. On the contrary, nearly identical courses of the transmission over the wavelength according to curves 25 and 26 result, when the refractive index is selectively varied by 1% in the first or second resonator. These curves 25 and 26 mean a clear reduction of the transmission in the original passband 22 without shifting the passband. If, however, the refractive index in the middle resonator is selectively varied by 1%, a curve 27 results, i. e. an even stronger reduction of the transmission in the passband 22 and a further a narrow bandwidth passband 28.

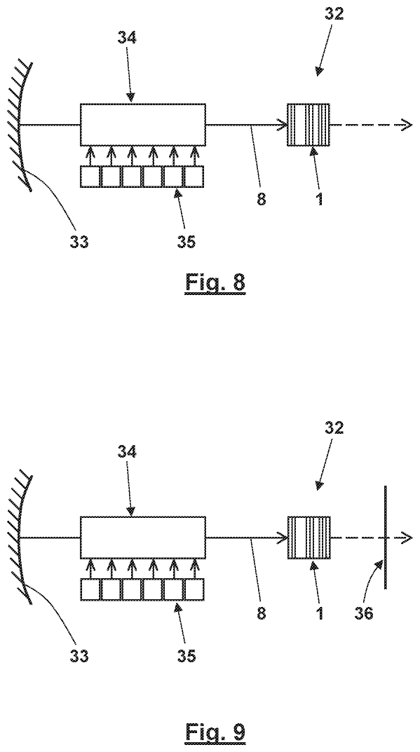

FIG. 8 strongly schematically depicts a laser resonator 32 which is formed between a mirror 33 and an optical element 1. In the laser resonator 32, laser active material 34 is arranged which is pumped by means of a pump light source 35. At low intensities of the light 8 in the resonator, the optical element 1 serves as an end mirror which becomes transparent, when the intensity of the light 8 at the design wavelength of the optical element 1 exceeds a predetermined intensity.

FIG. 9 illustrates another use of the optical element in a laser resonator 32 which is formed between the mirror 33 and a half transparent mirror 36. Here, the optical element 1 serves as a mode coupler or Q-switch which only becomes transparent when the light 8 in the part of the resonator 32 which is delimited by the optical element and which includes the laser active material 34 exceeds a certain minimum intensity at the design wavelength.

Many variations and modifications may be made to the preferred embodiments of the invention without departing substantially from the spirit and principles of the invention. All such modifications and variations are intended to be included herein within the scope of the present invention, as defined by the following claims.

We claim:

1. An optical element comprising
a design wavelength λ,
an optical axis, and
alternating refractive index changes along the optical axis,
wherein the alternating refractive index changes form
at least three reflectors and
at least two optical resonators
for light of the design wavelength λ incident along the optical axis,
wherein, along the optical axis, each of the at least two optical resonators is arranged between two of the at least three reflectors,
wherein at least one of the at least two optical resonators includes a Kerr-active material,
wherein the at least two optical resonators have total refractive indices n(i)=n₀(i)+I_{Res}(i)·n₂(i)
wherein I_{Res}(i) is a resulting intensity of the light of the design wavelength λ incident along the optical axis that results within the respective one of the at least two reflectors due to an arrangement of the respective one of the at least two reflectors between the respective two of the at least three reflectors, and
wherein n₂(i) is a non-linear refractive index of the respective resonator, and
wherein the at least two optical resonators differ with regard to non-linear components I_{Res}(i)·n₂(i) of their total refractive indices by at least 50% of that one of the non-linear components I_{Res}(i)·n₂(i) that is the smaller one in terms of absolute value.

2. The optical element of claim 1, wherein the at least three reflectors are all predominantly made of materials which are not Kerr-active and which comprise a total refractive index n(k)=n₀(k)+I·n₂(k) dependent on the intensity I of the light, wherein an absolute value of a non-linear refractive index n₂(k) is not more than a half of an absolute value of the non-linear refractive index n₂(i) of the at least one of the at least two optical resonators including the Kerr-active material.

3. The optical element of claim 1, wherein the at least three reflectors are all predominantly made of materials which are not Kerr-active and which comprise a total refractive index n(k)=n₀(k)+I·n₂(k) dependent on the intensity I of the light, wherein an absolute value of a non-linear refractive index n₂(k) is not more than a quarter of an absolute value of the non-linear refractive index n₂(i) of the at least one of the at least two optical resonators including the Kerr-active material.

4. The optical element of claim 2, wherein the absolute value of the non-linear refractive index n₂(k) of the materials of the at least three reflectors, which are not Kerr-active, is not more than 4.0×10⁻¹⁶ cm²/W.

5. The optical element of claim 2, wherein the absolute value of the non-linear refractive index n₂(k) of the materials of the reflectors, which are not Kerr-active, is not more than 3.0×10⁻¹⁶ cm²/W.

6. The optical element of claim 1, wherein at least a further one of the at least two optical resonators is at least predominantly made of material which is not Kerr-active such that it has a total refractive index n(p)=n₀(p)+I·n₂(p), wherein an absolute value of a non-linear refractive index n₂(p) is not more than a half of an absolute value of the non-linear refractive index n₂(i) of the at least one of the at least two optical resonators including the Kerr-active material.

7. The optical element of claim 1, wherein at least a further one of the resonators is at least predominantly made of material which is not Kerr-active such that it has a total refractive index n(p)=n₀(p)+I·n₂(p), wherein an absolute value of a non-linear refractive index n₂(p) is not more than a quarter of an absolute value of the non-linear refractive index n₂(i) of the at least one of the at least two optical resonators including the Kerr-active material.

8. The optical element of claim 6, wherein the absolute value of the non-linear refractive index n₂(p) of the at least one further one of the at least two optical resonators is not more than 4.0×10⁻¹⁶ cm²/W.

9. The optical element of claim 6, wherein the absolute value of the non-linear refractive index n₂(p) of the at least one further one of the at least two optical resonators is not more than 3.0×10⁻¹⁶ cm²/W.

10. The optical element of claim 1, wherein the Kerr-active material of the at least one of the at least two optical resonators is TiO₂.

11. The optical element of claim 10, and further comprising at least one of the following features:
Kerr-active material of at least a further one of the at least two optical resonators consisting of Ta₂O₅ or another metal oxide,
at least one of the at least three reflectors comprises SiO₂ as a material of low refractivity which is not Kerr-active, and
at least one of the at least three reflectors comprises Ta₂O₅ or another metal oxide as a material of high refractivity which is not Kerr-active.

12. The optical element of claim 1, wherein the Kerr-active material of the at least one of the at least two optical resonators has a total refractive index n_{Kerr}=n₀+I·n₂, wherein an absolute value of a non-linear refractive index n₂ of the Kerr-active material is at least 1×10⁻¹⁴ cm²/W.

13. The optical element of claim 1, wherein the Kerr-active material of the at least one of the at least two optical resonators has a total refractive index n_{Kerr}=n₀+I·n₂, wherein an absolute value of a non-linear refractive index n₂ of the Kerr-active material is at least 1×10⁻¹² cm²/W.

14. The optical element of claim 1, wherein the Kerr-active material of the at least one of the at least two optical resonators is a polymer.

15. The optical element of claim 1, wherein the Kerr-active material of the at least one of the at least two optical resonators is doped with nanoparticles which comprise at least one a metal and a semiconductor.

16. The optical element of claim 15, wherein the nanoparticles have a particle size in a range from 1 to 100 nm.

17. The optical element of claim 15, wherein the nanoparticles are at least predominantly made of gold, silver, platinum, palladium or copper.

18. The optical element of claim 1, wherein an increase of the intensity I of the light of the design wavelength λ incident along the optical axis either reduces or increases a transmission of the optical element in a passband around the design wavelength λ.

19. A use of an optical element of claim 1 in a laser resonator.

20. The use of claim 19, wherein the optical element is used as an optical switch in the laser resonator.

21. The use of claim 19, wherein the optical element is used as a mode coupler, a q-switch or a power safety switch in the laser resonator.

22. An optical element comprising
a design wavelengths λ,
an optical axis, and
alternating refractive index changes along the optical axis,
wherein the alternating refractive index changes form
at least two reflectors and
at least one optical resonator
for light of the design wavelength λ incident along the optical axis,
wherein, along the optical axis, the at least one optical resonator is arranged between the at least two reflectors,
wherein the at least one optical resonator includes a Kerr-active material such that the at least one optical resonator has a total refractive index n(i)=n₀(i)+I·n₂(i) dependent on the intensity I of the light,
wherein the Kerr-active material of the at least one optical resonator has a total refractive index n_{Kerr}=n₀+I·n₂, wherein an absolute value of a non-linear refractive index n₂ of the Kerr-active material is at least 1×10⁻¹⁴ cm²/W, and
wherein the Kerr-active material of the at least one optical resonator is selected from polymers and materials doped with nanoparticles, the nanoparticles comprising at least one of a metal or a semiconductor.

23. A use of an optical element of claim 22 in a laser resonator.

24. The use of claim 19, wherein the optical element is used as an optical switch in the laser resonator.

25. The use of claim 19, wherein the optical element is used as a mode coupler, a q-switch or a power safety switch in the laser resonator.
